(19) United States
(12) Patent Application Publication
(10) Pub. No.: US 2021/0216879 A1
(43) Pub. Date: Jul. 15, 2021

(54) METHODS AND SYSTEMS FOR IMPROVING HEURISTIC SEARCHES FOR ARTIFICIAL INTELLIGENCE PLANNING

(71) Applicant: INTERNATIONAL BUSINESS MACHINES CORPORATION, Armonk, NY (US)

(72) Inventors: Michael KATZ, Goldens Bridge, NY (US); Patrick Christoph FERBER, Baden-Wuerttemberg (DE)

(73) Assignee: INTERNATIONAL BUSINESS MACHINES CORPORATION, Armonk, NY (US)

(21) Appl. No.: 16/741,431

(22) Filed: Jan. 13, 2020

(51) Int. Cl. G06N 5/00; G06N 3/08; G06N 3/04

(52) U.S. Cl. CPC G06N 5/003; G06N 3/0427; G06N 3/08

(57) ABSTRACT

Embodiments for improving heuristic searching in artificial intelligence (AI) planning are provided. At least one planning task within a planning domain is identified. The at least one planning task is solved to generate a plurality of plans. The plurality of plans include a plurality of state-action pairs. A neural network is trained utilizing the plurality of state-action pairs. Preferred actions for states within the planning domain are determined utilizing the neural network.

### BACKGROUND OF THE INVENTION

### Field of the Invention

The present invention relates in general to computing systems, and more particularly, to various embodiments for improving heuristic searches for artificial intelligence planning.

### Description of the Related Art

Automated planning is a field of artificial intelligence (AI) that deals with solving problems that involve finding a strategy of action, provided the problems are modeled in a suitable input language. Automated planning may be utilized to realize, for example, strategies or action sequences for execution by intelligent agents, autonomous robots and unmanned vehicles, etc. In theory, optimal planning includes finding the single best solution to a problem. A wide variety of optimal planners exist, which are able to solve relatively large problems. However, no one tool has been determined to work well for all planning problems, and selecting a planner that works well on a given problem may be difficult and/or time-consuming.

In some instances, planning is solved utilizing heuristic searches (or searching), which is sometimes improved (or “boosted”) utilizing multiple opportunistic queues. There are several heuristic functions that have been implemented, which make use of preferred operators or “helpful” actions, most of them being based on delete relaxation. However, current search boosting techniques are rather simplistic, devising preferred operators from heuristics, using the same information as the heuristic, and the current collection of existing heuristics with defined and/or implemented preferred operators is extremely limited. The use of preferred operators from the same heuristic that guides the search biases the search towards the heuristic. As such, if the heuristic is incorrect, boosting the search in such a way may not be useful, and may even be counterproductive.

### SUMMARY OF THE INVENTION

Various embodiments for improving heuristic searching in artificial intelligence (AI) planning are provided. At least one planning task within a planning domain is identified. The at least one planning task is solved to generate a plurality of plans. The plurality of plans include a plurality of state-action pairs. A neural network is trained utilizing the plurality of state-action pairs. Preferred actions for states within the planning domain are determined utilizing the neural network.

In addition to the foregoing exemplary embodiment, various other system and computer program product embodiments are provided and supply related advantages. The foregoing Summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention; and

FIG. 4 is a flowchart diagram of an exemplary method for improving heuristic searching in artificial intelligence (AI) planning according to an embodiment of the present invention.

### DETAILED DESCRIPTION OF THE DRAWINGS

As discussed above, automated planning is a field of artificial intelligence (AI) that deals with solving problems that involve finding a strategy of action, provided the problems are modeled in a suitable input language. Automated planning may be utilized to realize, for example, strategies or action sequences for execution by intelligent agents, autonomous robots and unmanned vehicles, etc. In theory, optimal planning includes finding the single best solution to a problem. A wide variety of optimal planners exist, which are able to solve relatively large problems.

For example, satisficing planning generally attempts to determine any solution for a given task as quickly as possible, and if time/resources permit, improve upon the solution, providing or resulting in the best solution yet determined. While in agile planning, generally, one solution is generated as quickly as possible. However, these problems are, in general, considered to be PSPACE-hard. In other words, they are at least as difficult to solve as any other problems, with PSPACE being the set of all decision problems that can be solved by a Turing machine using a polynomial amount of space, as will be appreciated by one skilled in the art. Additionally, no one tool has been determined to work well for all planning problems, and selecting a planner that works well on a given problem may be difficult and/or time-consuming.

A major focus in classical planning was on heuristic searches, with heuristics automatically obtained for planning tasks, exploiting the task structure. In some instances, heuristic searches (or searching) are improved (or “boosted”) utilizing multiple opportunistic queues. There are several heuristic functions that have been implemented, which make use of preferred operators or “helpful” actions, most of them being based on delete relaxation. However, current search boosting techniques are rather simplistic, devising preferred operators from heuristics, using the same information as the heuristic, and the current collection of existing heuristics with defined and/or implemented preferred operators is extremely limited. The use of preferred operators from the same heuristic that guides the search biases the search towards the heuristic. As such, if the heuristic is incorrect, boosting the search in such a way may not be useful, and may even be counterproductive.

To address these needs and/or the shortcomings in the prior art, in some embodiments described herein, methods and/or systems are disclosed that, for example, learn to boost the search for a given domain (e.g., where actions are shared between instances within the domain) utilizing training data (e.g., in the form of state-action pairs) obtained from plans generated to solve relatively small instances in the domain. Using the training data, a neural network may be trained to search for and/or identify preferred actions for states (e.g., unseen states).

More specifically, in some embodiments, the methods and/or systems described herein may be utilized to boost searching within a given domain, where actions are shared between instances. Training data may be created (or obtained) by generating plans or solution paths for instances within the domain. A neural network may then be trained utilizing the training data, and then used to predict preferred actions for new states.

In some embodiments, the instances within the domain may be solved using, for example, top-k planning, diverse planning, and/or classical planning. For each generated plan, each of the states may be paired to an action along the plan, thus generating state-action pairs. After the neural network is trained, it may be utilized during the search to determine preferred actions for new/unseen states.

In some embodiments, the methods and/or systems described herein may utilize a “cognitive analysis,” “cognitive system,” “machine learning,” “cognitive modeling,” “predictive analytics,” and/or “data analytics,” as is commonly understood by one skilled in the art. Generally, these processes may include, for example, receiving and/or retrieving multiple sets of inputs, and the associated outputs, of one or more systems and processing the data (e.g., using a computing system and/or processor) to generate or extract models, rules, etc. that correspond to, govern, and/or estimate the operation of the system(s), or with respect to the embodiments described herein, boosting heuristic searches for AI planning, as described herein. Utilizing the models, the performance (or operation) of the system (e.g., utilizing/based on new inputs) may be predicted and/or the performance of the system may be optimized by investigating how changes in the input(s) effect the output(s). Feedback received from (or provided by) users and/or administrators may also be utilized, which may allow for the performance of the system to further improve with continued use.

It should be understood that as used herein, the term “computing node” (or simply “node”) may refer to a computing device, such as a mobile electronic device, desktop computer, etc. and/or an application, such a machine learning algorithm/model, chatbot, an email application, a social media application, a web browser, etc. In other words, as used herein, examples of computing nodes include, for example, computing devices such as mobile phones, tablet devices, desktop computers, or other devices, such as appliances (IoT appliances) that are owned and/or otherwise associated with individuals (or users), and/or various applications that are utilized by such computing devices.

In particular, in some embodiments, a method for improving heuristic searching in artificial intelligence (AI) planning (and/or for performing heuristic searching in AI planning), by a processor, is provided. At least one planning task within a planning domain is identified. The at least one planning task is solved to generate a plurality of plans. The plurality of plans include a plurality of state-action pairs. A neural network is trained utilizing the plurality of state-action pairs. Preferred actions for states within the planning domain are determined utilizing the neural network.

A heuristic search planning within the planning domain may be performed utilizing the preferred actions. The neural network may be configured to perform multi-class classification.

The solving of the at least one planning task may be performed utilizing top-k planning. The plurality of plans may include at least one of a reordering plan and a symmetrical plan. The solving of the at least one planning task may be performed utilizing diverse planning. The plurality of plans may be diverse by at least one diversity criterion. The solving of the at least one planning task may be performed utilizing classical planning.

The training of the neural network utilizing the plurality of state-action pairs may include converting the plurality of state-actions pairs to at least one representation that is consumable by machine learning algorithms. The at least one representation may include at least one of an image and a graph.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment, such as cellular networks, now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

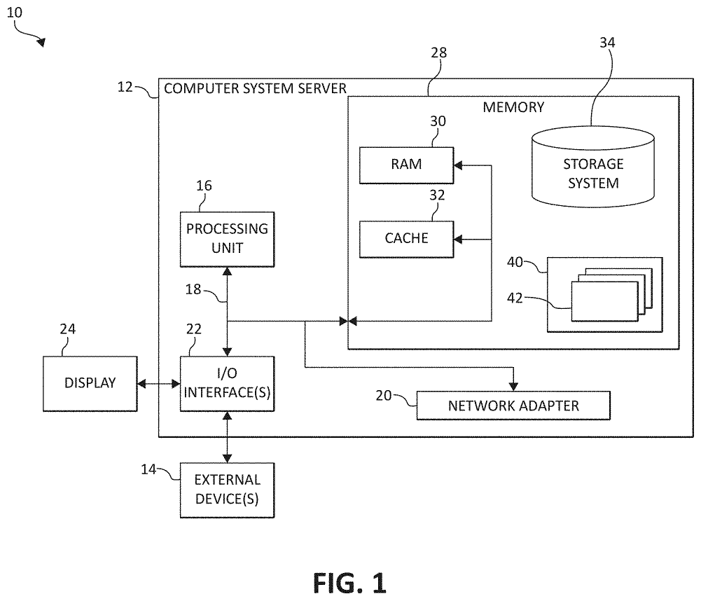

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 (and/or one or more processors described herein) is capable of being implemented and/or performing (or causing or enabling) any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in, for example, personal computer systems, server computer systems, thin clients, thick clients, hand-held or laptop devices, multiprocessor systems, microprocessor-based systems, set top boxes, programmable consumer electronics, network PCs, mobile electronic devices such as mobile (or cellular and/or smart) phones, personal data assistants (PDAs), tablets, wearable technology devices, laptops, handheld game consoles, portable media players, etc., as well as computing systems in vehicles, such as automobiles, aircraft, watercrafts, etc. However, in some embodiments, some of the components depicted in FIG. 1 may be located in a computing device in, for example, a satellite, such as a Global Position System (GPS) satellite. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

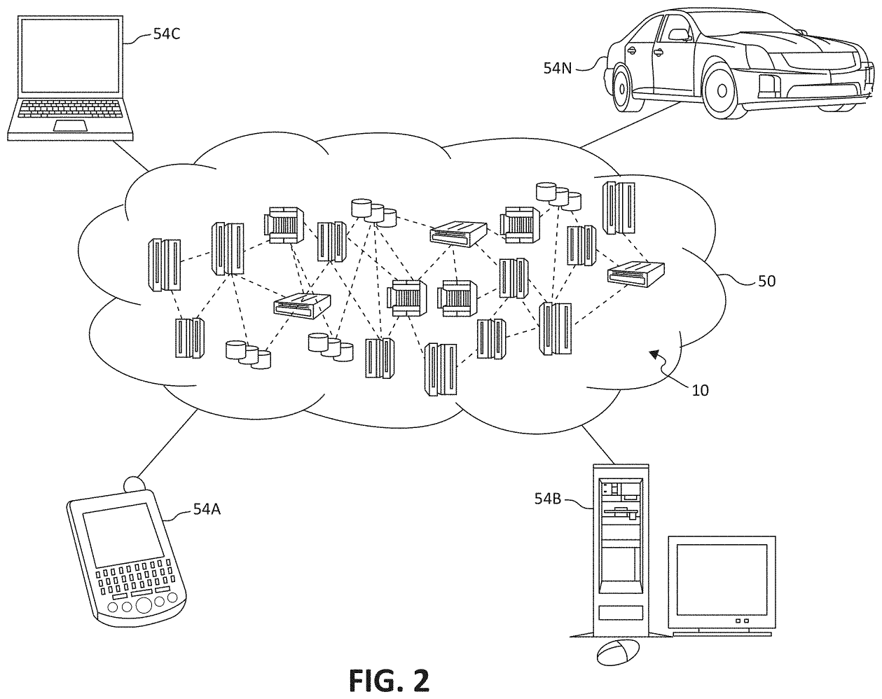

Referring now to FIG. 2, illustrative cloud computing environment 50 is depicted. As shown, cloud computing environment 50 comprises one or more cloud computing nodes 10 with which local computing devices used by cloud consumers, such as, for example, cellular (or mobile) telephone or PDA 54A, desktop computer 54B, laptop computer 54C, and vehicular computing system (e.g., integrated within automobiles, aircraft, watercraft, etc.) 54N may communicate.

Still referring to FIG. 2, nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

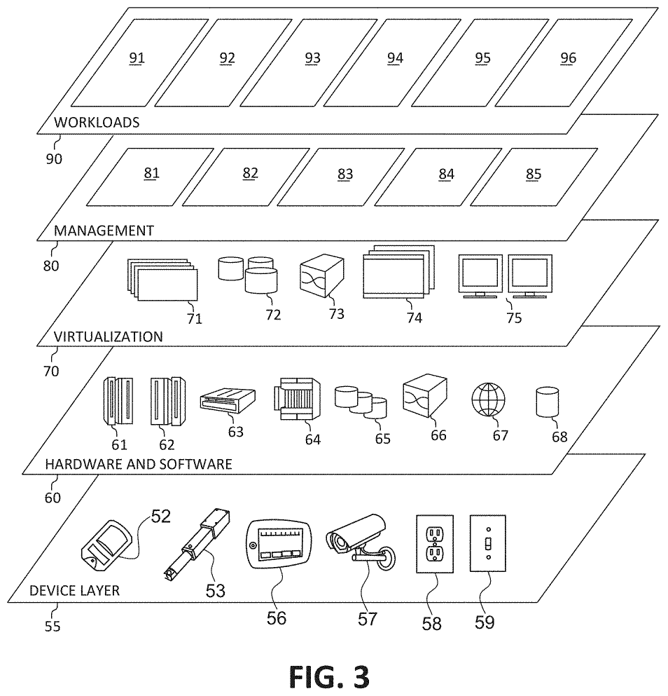

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to, various additional sensor devices, networking devices, electronics devices (such as a remote control device), additional actuator devices, so called “smart” appliances such as a refrigerator, washer/dryer, or air conditioning unit, and a wide variety of other possible interconnected devices/objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for boosting heuristic searches for AI planning, as described herein. One of ordinary skill in the art will appreciate that the workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, in some embodiments, methods and/or systems are provided that, for example, improve heuristic searching in artificial intelligence (AI) planning and/or for performing heuristic searching in AI planning. At least one planning task within a planning domain is identified. The at least one planning task is solved to generate a plurality of plans. The plurality of plans include a plurality of state-action pairs. A neural network is trained based on (or utilizing) the plurality of state-action pairs. Preferred actions for states within the planning domain are determined utilizing the neural network.

A heuristic search planning within the planning domain may be performed utilizing the preferred actions. The neural network may be configured to perform multi-class classification. The solving of the at least one planning task may be performed utilizing top-k planning, and the plurality of plans may include at least one of a reordering plan and a symmetrical plan. The solving of the at least one planning task may be performed utilizing diverse planning, and the plurality of plans may be diverse by at least one diversity criterion. The solving of the at least one planning task may be performed utilizing classical planning.

The training of the neural network based on the plurality of state-action pairs may include converting the plurality of state-actions pairs to at least one representation that is consumable by machine learning algorithms. The at least one representation may include at least one of an image and a graph.

In some embodiments, a planning domain is first selected. The planning domain may be any suitable domain to which AI planning may be applied. Examples include, but are not limited to, plans executed by intelligent agents, autonomous robots and unmanned vehicles, the control of elevators, cognitive assistants, cyber security, service composition, traffic planning/control, etc. Within the domain, relatively small planning tasks (or instances) are generated. For example, the generated planning tasks may include instances with a relatively small number of states and relatively simple goals, as will be appreciated by one skilled in the art. The generated tasks/instances may have a variety of initial states and goal states.

In some embodiments, each of the instances (or tasks) is solved utilizing a known AI planning technique/method (or system). For example, the instances may be solved utilizing a classical planner (or classical planning), a top-k planner, and/or a diverse planner, as will be appreciated by one skilled in the art. The result of solving the instances may be a collection of plans.

Each of the plans may be considered to be (or include) a sequence of interchanging states and actions, with the final state being a goal (e.g., s₀, a₀, s₁, a₁, . . . , g). The system may then collect or gather state-action pairs from the plans, with each state-action pair including a state along with the action that is performed immediately after that state (e.g., <sᵢ, aᵢ>). A dataset (i.e., a single dataset) (D) may be formed from the gather state-action pairs. Training data may then be generated as follows.

For each state (s) in or along any plan, let A={a|<s, a> in D} be all the actions that are paired with s (there can be more than one). Each data point in the training set created may be in a form that is consumable by a machine learning algorithm or model, as is commonly understood. For example, each data point may be a graph or an image representing a planning task, where s replaces the initial state in the planning task, and A is turned into a Boolean vector indicating whether the action is present in A.

Using the training data, a neural network may be trained (or built/constructed) to predict which actions are preferred in state (e.g., new/unseen states). The neural network may include and/or utilize multi-class classification (and/or a multi-class classification model).

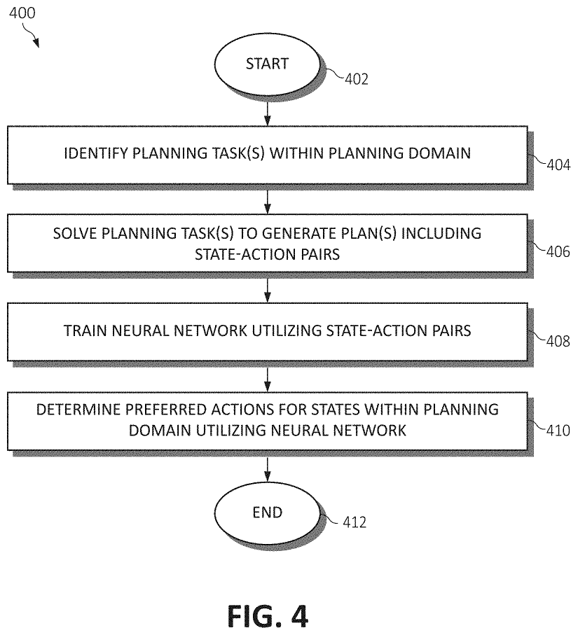

Turning to FIG. 4, a flowchart diagram of an exemplary method 400 for improving heuristic searching in artificial intelligence (AI) planning (and/or for performing heuristic searching in AI planning) is provided. The method 400 begins (step 402) with, for example, a planning domain being selected. The planning domain may be any suitable domain to which AI planning may be applied. Examples include, but are not limited to, plans executed by intelligent agents, autonomous robots and unmanned vehicles, the control of elevators, cognitive assistants, cyber security, service composition, traffic planning/control, etc.

At least one planning task (e.g., more than one) within the planning domain is identified (or selected, generated, etc.) (step 404). For example, the identified planning tasks may include instances with a relatively small number of states and relatively simple goals, as will be appreciated by one skilled in the art. The generated tasks/instances may have a variety of initial states and goal states.

The at least one planning task is solved to generate a plurality of plans (or at least one plan) (step 406). The plan(s) may include a plurality of state-action pairs. As one example, the solving of the at least one planning task may be performed utilizing top-k planning, and the plurality of plans may include at least one of a reordering plan and a symmetrical plan. Alternatively, the solving may be performed utilizing diverse planning, and the plurality of plans may be diverse by at least one diversity criterion. However, the solving may also be performed utilizing classical planning.

A neural network is trained utilizing (and/or based on) the plurality of state-action pairs (step 408). The training of the neural network utilizing the plurality of state-action pairs may include converting the plurality of state-actions pairs to at least one representation that is consumable by machine learning algorithms. The at least one representation may include at least one of an image and a graph.

Preferred actions for states within the planning domain are determined utilizing the neural network (step 410). The neural network may be configured to perform multi-class classification (and/or utilize a multi-class classification model).

Method 400 ends (step 412) with, for example, heuristic search planning (or AI planning boosted with a heuristic search) being performed utilizing the preferred actions. In some embodiments, feedback from users may also be utilized to improve the performance of the system over time.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for improving heuristic searching in artificial intelligence (AI) planning comprising:
identifying at least one planning task within a planning domain;
solving the at least one planning task to generate a plurality of plans, wherein the plurality of plans include a plurality of state-action pairs;
training a neural network utilizing the plurality of state-action pairs; and
determining preferred actions for states within the planning domain utilizing the neural network.

2. The method of claim 1, further comprising performing a heuristic search planning within the planning domain utilizing the preferred actions.

3. The method of claim 1, wherein the solving of the at least one planning task is performed utilizing top-k planning, and wherein the plurality of plans include at least one of a reordering plan and a symmetrical plan.

4. The method of claim 1, wherein the solving of the at least one planning task is performed utilizing diverse planning, and wherein the plurality of plans are diverse by at least one diversity criterion.

5. The method of claim 1, wherein the solving of the at least one planning task is performed utilizing classical planning.

6. The method of claim 1, wherein the training of the neural network utilizing the plurality of state-action pairs includes converting the plurality of state-actions pairs to at least one representation that is consumable by machine learning algorithms, wherein the at least one representation includes at least one of an image and a graph.

7. The method of claim 1, wherein the neural network is configured to perform multi-class classification.

8. A system for improving heuristic searching in artificial intelligence (AI) planning comprising:
a processor executing instructions stored in a memory device, wherein the processor:
identifies at least one planning task within a planning domain;
solves the at least one planning task to generate a plurality of plans, wherein the plurality of plans include a plurality of state-action pairs;
trains a neural network utilizing the plurality of state-action pairs; and
determines preferred actions for states within the planning domain utilizing the neural network.

9. The system of claim 8, wherein the processor further performs a heuristic search planning within the planning domain utilizing the preferred actions.

10. The system of claim 8, wherein the solving of the at least one planning task is performed utilizing top-k planning, and wherein the plurality of plans include at least one of a reordering plan and a symmetrical plan.

11. The system of claim 8, wherein the solving of the at least one planning task is performed utilizing diverse planning, and wherein the plurality of plans are diverse by at least one diversity criterion.

12. The system of claim 8, wherein the solving of the at least one planning task is performed utilizing classical planning.

13. The system of claim 8, wherein the training of the neural network utilizing the plurality of state-action pairs includes converting the plurality of state-actions pairs to at least one representation that is consumable by machine learning algorithms, wherein the at least one representation includes at least one of an image and a graph.

14. The system of claim 8, wherein the neural network is configured to perform multi-class classification.

15. A computer program product for improving heuristic searching in artificial intelligence (AI) planning, by a processor, the computer program product embodied on a non-transitory computer-readable storage medium having computer-readable program code portions stored therein, the computer-readable program code portions comprising:
an executable portion that identifies at least one planning task within a planning domain;
an executable portion that solves the at least one planning task to generate a plurality of plans, wherein the plurality of plans include a plurality of state-action pairs;
an executable portion that trains a neural network utilizing the plurality of state-action pairs; and
an executable portion that determines preferred actions for states within the planning domain utilizing the neural network.

16. The computer program product of claim 15, wherein the computer-readable program code portions further include an executable portion that performs a heuristic search planning within the planning domain utilizing the preferred actions.

17. The computer program product of claim 15, wherein the solving of the at least one planning task is performed utilizing top-k planning, and wherein the plurality of plans include at least one of a reordering plan and a symmetrical plan.

18. The computer program product of claim 15, wherein the solving of the at least one planning task is performed utilizing diverse planning, and wherein the plurality of plans are diverse by at least one diversity criterion.

19. The computer program product of claim 15, wherein the solving of the at least one planning task is performed utilizing classical planning.

20. The computer program product of claim 15, wherein the training of the neural network utilizing the plurality of state-action pairs includes converting the plurality of state-actions pairs to at least one representation that is consumable by machine learning algorithms, wherein the at least one representation includes at least one of an image and a graph.

21. The computer program product of claim 15, wherein the neural network is configured to perform multi-class classification.
